(19) United States
(12) Patent Application Publication
(10) Pub. No.: US 2026/0025259 A1
(43) Pub. Date: Jan. 22, 2026

(54) SERDES SAMPLING SCOPE DEBUG MODE

(71) Applicant: Marvell Asia Pte Ltd, Singapore (SG)

(72) Inventors: Luca Vercesi, Pavia (IT); Fernando De Bernardinis, Pavia (IT)

(73) Assignee: Marvell Asia Pte Ltd, Singapore (SG)

(21) Appl. No.: 19/272,032

(22) Filed: Jul. 17, 2025

Related U.S. Application Data
(60) Provisional application No. 63/673,212, filed on Jul. 19, 2024.

(51) Int. Cl. H04L 7/033

(52) U.S. Cl. CPC H04L 7/033

(57) ABSTRACT

A clock recovery loop in a digital signal processor for a serializer-deserializer data interface can be modified to achieve fractional lock and operate in a sampling scope mode. The clock recovery loop can control a phase locked loop to produce a clock signal that is at a rational fraction of a baud rate. The clock signal can be used by time-interleaved analog-to-digital converters to achieve oversampling of a periodic signal received over a receive channel. The samples can be used to reconstruct a continuous time signal bit response to characterize or debug the receive channel.

### PRIORITY APPLICATION

This patent application claims priority to and/or receives benefit from U.S. Provisional Application No. 63/673,212, titled, “SerDes Sampling Scope Mode”, filed on Jul. 19, 2024. The U.S. Provisional Application is hereby incorporated by reference in its entirety.

### BACKGROUND

High-speed, high-bandwidth communication systems are integral to modern computing and networking applications. These systems are designed to facilitate efficient and reliable data transmission over various media, including optical fibers, copper cables, and wireless channels. Advances in communication technologies, such as signal modulation, error correction, and clock recovery, can ensure data integrity, reduce latency, and maintain synchronization across devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary electronics system, according to some embodiments of the disclosure.

FIG. 2 illustrates an implementation of a digital signal processor with a single bit response diagnostics part, according to some embodiments of the disclosure.

FIG. 3 illustrates a clock recovery loop, according to some embodiments of the disclosure.

FIG. 4 illustrates analog-to-digital converter lanes sampling at different times, according to some embodiments of the disclosure.

FIG. 5 illustrates a clock recovery loop configured to achieve fractional lock, according to some embodiments of the disclosure.

FIG. 6 illustrates achieving fractional lock, according to some embodiments of the disclosure.

FIG. 7 illustrates achieving fractional lock, according to some embodiments of the disclosure.

FIG. 8 illustrates determining single bit response diagnostics data, according to some embodiments of the disclosure.

FIG. 9 illustrates determining single bit response diagnostics data, according to some embodiments of the disclosure.

FIG. 10 illustrates determining single bit response diagnostics data, according to some embodiments of the disclosure.

FIG. 11 depicts a flow chart illustrating a method to extract a single bit response using an augmented clock recovery loop achieving fractional lock, according to some embodiments of the disclosure.

FIG. 12 depicts a flow chart illustrating a method to extract a single bit response using an augmented clock recovery loop achieving fractional lock, according to some embodiments of the disclosure.

### DETAILED DESCRIPTION

### Overview

As artificial intelligence (AI) applications continue to evolve, they demand unprecedented data processing speeds and bandwidth capabilities to support their complex algorithms and massive datasets. Digital signal processors (DSPs), such as optical DSPs, can enable high-bandwidth optical interconnects for AI infrastructure. In particular, the DSPs can enable low-latency, high-performance, and energy-efficient data transfer. These DSPs can offer seamless connectivity across AI, cloud computing, enterprise systems, and 5G infrastructure.

Single bit response (SBR), also referred to as pulse response, can characterize or debug a communication link. The characterization technique operates under the assumption that the transmitter (TX) channel, and receiver (RX) channel exhibit linear behavior. SBR, SBR(t), can be represented as a continuous time function and serves as a powerful diagnostic tool for understanding the propagation of a single pulse or a single bit through a communication channel. This SBR characterization formulates a linear channel model that can be used to predict the expected signal a(t) from a known data sequence dₖ, such as dummy data or a well-characterized signal. The mathematical formulation relating the known transmitted data sequence dₖ to the expected received signal a(t) is as follows:

$$a ( t ) = {\sum }_{k} S BR ( t - kT ) \cdot {d}_{k} \qquad ( eq . 1 )$$

By comparing the predicted signal against the actual output, finer impairments on the channel, including inter-symbol interference (ISI) where overlapping signals degrade performance, rare events, and higher-order non-linearities, can be extracted and addressed. Furthermore, the SBR characterization allows for the identification of reflections or echoes within the communication link, even when they are faint or exhibit large delays.

Equalizers are tasked to undo, address, or compensate for ISI. Accurate characterization and/or debugging of the communication channel using SBR can remove ISI and enable the equalizers to perform better. When equalizers perform better, the overall system can perform better. Having the SBR can be invaluable for troubleshooting and debugging a communication channel, because the SBR can inform engineers of anomalies within the communication channel when the expected performance is not achieved. The SBR can offer insight into whether the equalizer is effectively mitigating ISI or whether other abnormalities, such as signal traffic issues, are impacting performance.

It is not trivial to collect samples of a received signal that can be used to reconstruct a continuous time SBR. Some solutions add significant complexity, power, and area to the circuitry. To address this issue, a clock recovery loop in a DSP for a serializer-deserializer (SerDes) data interface can be modified, augmented, or reconfigured to achieve fractional lock and operate in a sampling scope mode.

In normal SerDes operation, the clock recovery loop drives a phase locked loop (PLL) to produce a clock signal at a baud rate (BR). The BR in a SerDes interface refers to the number of symbol changes or signaling events per second, representing the rate at which data is transmitted over the communication channel. The clock signal can then be used by time-interleaved analog-to-digital converters (ADCs) to sample the incoming signal received over the communication channel at the BR. Samples produced by the time-interleaved ADCs are processed by respective parallel equalizers, and outputs of the parallel equalizers are processed by respective parallel slicers.

The clock recovery loop takes the outputs of the parallel equalizers and the outputs of the parallel slicers and uses the information to determine a frequency control word to the phase locked loop to minimize the timing error. Specifically, the clock recovery loop can include a timing error detector. The timing error detector can receive errors and the outputs of the slicers and output parallel timing errors. The errors received can be determined based on the outputs of the equalizers and the outputs of the slicers, e.g., by finding the differences between the outputs. A circuit in the clock recovery loop can sum or average the parallel timing errors to produce a timing error, which is then provided as an input to a controller (e.g., a feedback controller or Proportional-Integral-Derivative (PID) controller). The controller can produce the frequency control word to minimize the timing error. The feedback loop action of the clock recovery loop driving the timing error to be zero can cause the clock frequency to lock at a stable operating point at the baud rate.

The modification of the clock recovery loop involves configuring the circuit to sum or average the parallel timing errors to produce the timing error to operate in a selection or downsampling mode. The circuit can select or downsample the parallel timing errors at a downsampling rate of P, or 1 out of P parallel timing errors. A mode enable signal (or a mode control signal) can be used to configure the circuit to operate in different modes, such as in a summing/averaging mode, or in a selection/downsampling mode. Equivalently, the modification of the clock recovery loop can involve switching off the circuit to sum or average the parallel timing errors to produce the timing error and switching on a further circuit to select one of the parallel timing errors or downsample the parallel timing errors to produce the timing error. The mode enable signal can be used to switch in the further circuit to perform selection or downsampling of the parallel timing errors. In either scenario, an insignificant amount of hardware is added or changed to allow for the clock recovery loop to be configured to operate in this manner.

When the circuit in the clock recovery loop operates in the selection or downsampling mode, the feedback loop action of the clock recovery loop driving the timing error to be zero can cause the clock recovery loop to lock at a unique stable operating point that is not the baud rate. Specifically, the downsampling rate of P can cause the clock recovery loop's controller to output a frequency control word that would control the PLL to produce a clock signal at a rational fraction of BR, such as

$$\frac{P + 1}{P} * BR or \frac{P - 1}{P} * B R .$$

If P is sufficiently large, the clock signal can have a frequency near BR but not at BR.

The clock signal near BR can be used by time-interleaved ADCs to achieve oversampling of a predetermined periodic signal received over a receive channel, by performing sampling of the periodic signal over one or more or many periods or cycles of the periodic signal. This mode of operation is referred to herein as sampling scope mode. The closer to BR, the finer, higher resolution samples or higher effective oversampling rate can be achieved. The samples can be used to reconstruct a continuous time SBR to accurately and effectively characterize or debug the receive channel.

In some embodiments, a hardware correlator is implemented to correlate expected samples against the samples made by the time-interleaved ADCs near the BR to extract SBR. In some embodiments, a memory is used to capture the samples made by the time-interleaved ADCs at near the BR. A software correlator can be implemented to perform cross-correlation using the data stored in the memory to extract SBR.

The technique can be used at different points of the lifecycle of a receiver or a transceiver. In one example, a debug mode enable signal and a predetermined periodic signal can be applied when a receiver or transceiver is on a test bench, and an engineer can extract diagnostics data for further analysis. In one example, the debug mode enable signal can be applied when a transceiver is taken offline to collect diagnostics. A loop back path from the TX portion of the transceiver to the RX portion of the transceiver can be used to apply the predetermined periodic signal to allow the transceiver to perform built-in self-test or self-calibration. The TX portion can output a predetermined periodic signal and apply the signal via the loop back path. In one example, the debug mode enable signal and the predetermined periodic signal can be applied when a receiver or a transceiver is being tested during manufacturing and/or packaging. In one example, the debug mode enable signal can be applied when a transceiver is being tested or verified during manufacturing or packaging, and the predetermined periodic signal can be applied via a loop back path from the TX portion of the transceiver to the RX portion of the transceiver to allow the transceiver to perform built-in self-test or self-calibration.

The technique to modify the clock recovery loop to operate in a sampling scope mode can be used effectively to determine a continuous time SBR from the time-interleaved ADCs samples of a predetermined periodic signal without the need to add significant amount of circuitry to the transceiver. The continuous SBR can be used to improve verifiability, testability, and debuggability of transceiver systems. The continuous SBR can be used to estimate the transfer function of the analog front-end of the transceiver, such as the modulus and phase response. The continuous SBR can allow reflections and issues with the package or board having the transceiver to be identified. The continuous SBR can allow jitter and breakdown of jitter components to be identified.

### Techniques to Extract SBR

SBR can be measured by computing a cross-correlation between the received signal and the transmitted data sequence:

$$S B R ( t ) = \frac{E ( a ( kT + t ) \cdot {d}_{k} )}{E ( {d}_{k}^{2} )} \qquad ( eq . 2 )$$

Measurement of the received signal, a(t), can be done by sampling the received signal when a known or predetermined data sequence is transmitted. An example of a predetermined data sequence is a pseudorandom sequence signal, such as a pseudorandom binary sequence (PRBS) signal. Another example of a predetermined data sequence is dummy data. If the error rate is sufficiently low, decision directed measurement of the received signal, a(t), can be done by sampling the received signal when signal traffic is transmitted, where receiver decisions about the transmitted symbols are used.

In some cases, a hardware correlator is implemented to calculate equation 2. Samples of at the output of an ADC can be stored in a memory, such as a programmable first-in first-out (FIFO) memory. Outputs of a slicer can be stored in a further memory, such as a programmable FIFO memory. Programmability of the memory and the further memory can change the timing alignment between the ADC samples and the slicer outputs. The aligned data are multiplied together using a multiplier circuit to produce a product representing correlation values. The average of the products can be calculated by an averaging circuit to normalize the correlation values to produce the cross-correlation.

In some cases, a software correlator is implemented to calculate equation 2. Samples at the output of the ADC digitizing a known, predetermined data sequence, can be captured in memory, and an algorithm can be executed on a processor to calculate the cross-correlation between the samples and the predetermined data sequence.

The ADC in the RX portion of a transceiver with high-speed SerDes would sample the received signal at baud rate, which means that only a discrete time SBR can be constructed from the ADC samples. Discrete time SBR doesn't capture information at different phases of the signal. SBR is a continuous time function, with significant energy beyond the Nyquist frequency, (e.g., BR/2). Information theory explains that the energy cannot be extracted from samples taken at BR.

To construct a continuous time SBR, samples taken at a much higher frequency or rate than BR can be used. For high-quality continuous time reconstruction of SBR, an oversampling factor of 4 or more can be used, meaning that the sampling rate is 4 or more times the Nyquist frequency. It is not trivial to obtain samples at a high sampling rate to construct the continuous time SBR.

In some implementations, an auxiliary ADC and phase interpolator are added to the receiver circuitry to perform oversampling of the received signal. However, the design of the phase interpolator is not trivial. Matching between the main ADC and the auxiliary ADC can be a challenge. The auxiliary ADC and phase interpolator adds extra power, area, and complexity. Not to mention that adding the auxiliary ADC complicates the fan-out of the input analog signal to both the main ADC and the auxiliary ADC.

### Understanding Eye Diagrams

An eye diagram is a useful visualization tool widely used in communication systems to analyze the quality of high-speed digital signal transmissions. An eye diagram can be generated by overlaying multiple data signal waveforms received over a communication channel. This superimposition creates a pattern resembling an eye, from which various signal characteristics can be examined.

As discussed previously, the SBR characterizes or represents the behavior of a signal when transmitting a single bit through a channel. An eye diagram can capture the shape of the bit waveform as the single bit passes through the system. Ideally, this waveform would be perfectly square, but in reality, imperfections or impairments in the transmission medium or electronic components cause deviations. By examining the height, width, and opening of the eye pattern, engineers can determine how well the system handles a single bit of data. The vertical opening of the eye, or eye height, indicates the signal-to-noise ratio. A larger height suggests a cleaner signal with less noise. The horizontal opening, or eye width reflects the timing margin. A wider eye allows for greater tolerance to timing jitter. The consistency of the points where the signal transitions cross, or crossing points, provides information about timing stability and distortion.

Noise introduces random variations in the signal's amplitude. In the eye diagram, noise manifests as a spreading or fuzziness around the edges of the signal transitions. A signal with low noise will display sharp, well-defined edges, while excessive noise will blur these boundaries, potentially leading to errors in bit detection. Jitter refers to the variability in the timing of signal transitions. Jitter can appear in the eye diagram as horizontal deviations or smearing of the signal's rising and falling edges. Excessive jitter reduces the width of the eye opening, which can lead to timing errors when the signal is sampled. Distortion occurs when the signal deviates from its ideal shape due to non-linearities in the transmission system or bandwidth limitations. In the eye diagram, distortion is evident in the asymmetrical or irregular shape of the eye opening. It can appear as skewed transitions, rounded shoulders, or uneven heights in the waveform.

### Exemplary Computing System

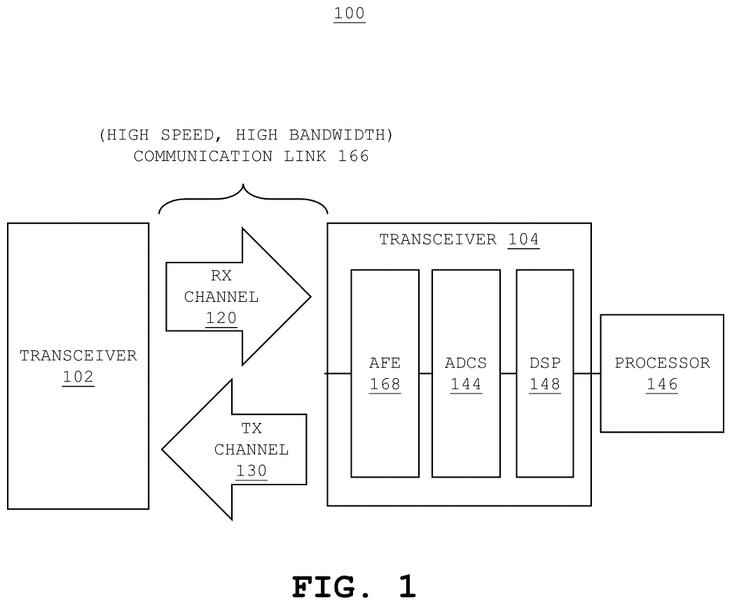

FIG. 1 illustrates an exemplary electronics system 100, according to some embodiments of the disclosure. Electronics system 100 can be used in high-speed, high-bandwidth communication applications. Electronics system 100 can include one or more components to carry out functionalities, including, among other things, effective signal transmission, reception, diagnostics, and clock recovery functionality. Electronics system 100 includes transceiver 102 and transceiver 104. Transceiver 104 can carry out communication functionalities for processor 146. For simplicity, the processor that transceiver 102 is carrying out communication functionalities is omitted in the figure.

Processor 146 may perform data processing tasks. Processor 146 can include one or more suitable types of processors, and one or more suitable number of processors. Processor 146 may be a single-core processor, or a multi-core (e.g., ARM or x86 processor cores). Examples of processor 146 may include a central processing unit (CPU), a graphics processing unit (GPU), a field-programmable gate array (FPGA), a tensor processing unit (TPU), a data processing unit (DPU), a DSP, an application specific integrated circuit (ASIC), etc. Processor 146 can execute instructions or commands of an operating system. Processor 146 can perform operations and/or computations for an application of electronics system 100.

Transceiver 104 can enable transmission and reception of signals over (high-speed, high-bandwidth) communication link 166. In this example, communication link 166 can include one or more of: RX channel 120, and TX channel 130. RX channel 120 can have one or more RX data lanes. TX channel 130 can have one or more TX data lanes.

Transceiver 102 can transmit data over RX channel 120 to transceiver 104 and can include circuitry to support transmission of data. Incoming data signals transmitted over RX channel 120 can be received by transceiver 104. Transceiver 104 has circuitry that processes the received data signals. Transceiver 104 can include an analog front-end (AFE) 168, which may include one or more amplifiers or other analog circuits to process the received data signals before the data signals are provided to ADCs 144. ADCs 144 can digitize the analog signals and output digital outputs or digital samples for further processing by DSP 148. For high-speed, high-bandwidth data interfaces, ADCs 144 include time-interleaved ADCs used to sample an analog signal received on RX channel 120 to achieve the baud rate of the communication channel. Time-interleaved ADCs 144 can take turns, one after another, or in a randomized fashion, to sample the received analog signal at different sampling points to produce the digitized samples of the received analog signal.

Transceiver 104 can transmit signals to transceiver 102 via TX channel 130, and transceiver 104 can include additional circuitry to prepare data signals to be transmitted over TX channel 130. Transceiver 104 can include TX circuitry to ensure faithful signal transmission over communication link 166.

DSP 148 can manage data processing tasks within transceiver 104. DSP 148 can include circuitry to perform one or more operations or computations. DSP 148 can include circuitry that can execute instructions and carry out one or more operations or computations. Examples of operations or computations can include, but are not limited to, diagnostics, control algorithms, signal processing, filtering, decision making or slicing, and equalization.

While the description is focused on transceiver 104, it is envisioned that various embodiments described herein are applicable to transceiver 102. It is also envisioned that various embodiments described herein are applicable to receivers, and not necessarily transceivers.

### Sampling Scope Mode Solution

To address shortcomings of other solutions, the DSP is modified to incorporate a SBR diagnostics part to modify, augment, or configure the clock recovery loop to operate in a sampling scope mode and obtain samples of a predetermined periodic signal. The samples can be used to reconstruct a high-resolution continuous time SBR to characterize an RX channel.

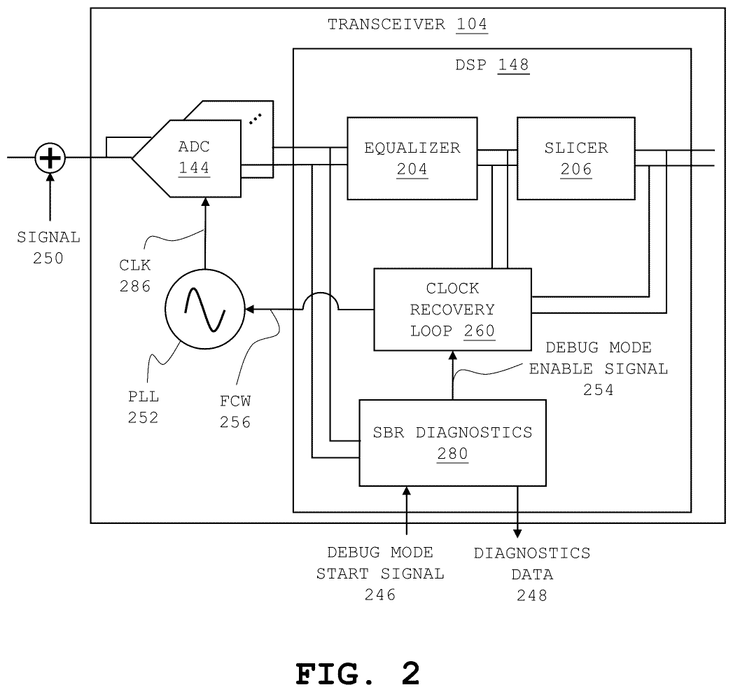

FIG. 2 illustrates an implementation of DSP 148 with SBR diagnostics 280, according to some embodiments of the disclosure. As discussed with FIG. 1, DSP 148 can include circuits to support reception of data for transceiver 104. DSP 148 performs digital signal processing, such as equalization to minimize errors in the recovered symbols and preserve signal integrity and slicing to decide what symbol was received.

DSP 148 can include parallel equalizers coupled to respective outputs of time-interleaved ADCs 144 digitizing an analog signal received on an RX channel. The parallel equalizers are shown collectively as equalizer 204. Equalizer 204 can be tasked to remove impairments such as ISI and correct distortions introduced by the RX channel. Equalizer 204 can enhance the fidelity of the received data by compensating for bandwidth limitations.

DSP 148 can include parallel slicers coupled to respective outputs of the equalizers. The parallel slicers are shown collectively as slicer 206. Slicer 206 determines which symbol was transmitted based on the output from equalizer 204. Slicer 206 evaluates and interprets the output and converts it into discrete digital data. Slicer 206 can compare the amplitude of each signal sample against predefined decision thresholds. These thresholds correspond to specific symbol levels in the modulation scheme being used (e.g., binary for binary phase-shift keying, multiple levels for quadrature amplitude modulation). Based on this comparison, slicer 206 determines which symbol the received sample represents.

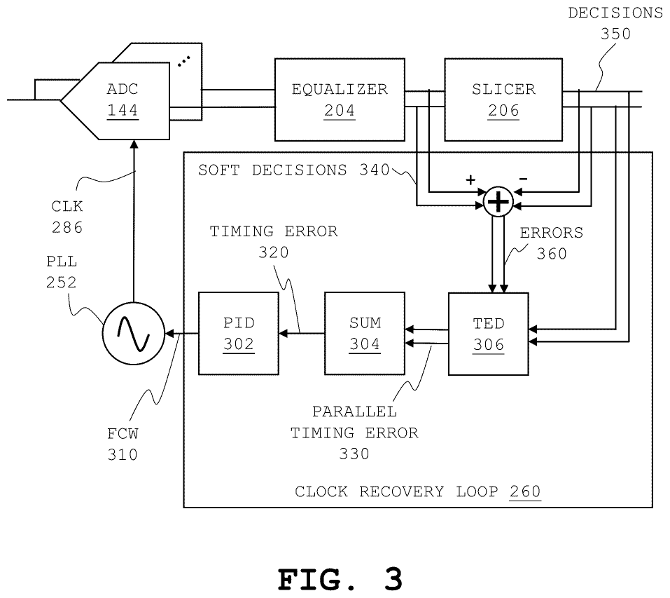

To address timing challenges that are inherent in high-speed systems, DSP 148 includes clock recovery loop 260 to control PLL 252 through frequency control word (FCW) 256. Clock recovery loop 260 ensures that PLL 252 produces a stable clock signal, CLK 286, to be used by time-interleaved ADCs 144 to sample the received signal. During normal operation of the SerDes interface, CLK 286 is at the baud rate of the interface. Clock recovery loop 260 implements a feedback action loop to ensure that CLK 286 is stable by controlling PLL 252 with FCW 256. Additional details of clock recovery loop 260 are described with FIG. 3.

DSP 148 includes SBR diagnostics 280, which may include circuits to output debug mode enable signal 254 to configure clock recovery loop 260 to operate in a sampling scope mode. A predetermined periodic signal 250 can be applied at the input of transceiver 104, such as a receive portion of transceiver 104, while clock recovery loop 260 operates in the sampling scope mode. The receive portion of transceiver 104 can receive predetermined periodic signal 250.

When clock recovery loop 260 is operating in the sampling scope mode, CLK 286 is locked to a rational fraction of BR. Samples made at the rational fraction of BR over one or more, or several periods of predetermined periodic signal 250 are collected and processed by SBR diagnostics 280. ADCs 144 can sample predetermined periodic signal 250 received over the RX channel using CLK 286 produced by PLL 252. The samples can be used to reconstruct a high-resolution continuous time SBR to characterize an RX channel. SBR can be determined using digital outputs of time-interleaved ADCs 144.

In some embodiments, predetermined periodic signal 250 may be applied by a component that is external to DSP 148 and/or transceiver 104. In some embodiments, predetermined periodic signal 250 is applied using a transmit portion of transceiver 104. Predetermined periodic signal predetermined periodic signal 250 is received via a loop back path from the transmit portion to a receive portion of transceiver 104.

In some embodiments, SBR diagnostics 280 may receive a debug mode start signal 246 from a component external to DSP 148 and/or transceiver 104. SBR diagnostics 280 may output diagnostics data 248 to a component external to DSP 148 and/or transceiver 104, such as the samples collected, or a derivation thereof.

In some embodiments, SBR diagnostics 280 may receive a debug mode start signal 246 from a component internal to DSP 148 and/or transceiver 104. SBR diagnostics 280 may output diagnostics data 248 to a component internal to DSP 148 and/or transceiver 104, such as the samples collected, or a derivation thereof.

Debug mode start signal 246 can be applied to transceiver 104 to trigger transceiver 104 to start operating in a debug mode. In response, SBR diagnostics 280 can output debug mode enable signal 254 to configure clock recovery loop 260 to operate in sampling scope mode and to collect samples for SBR reconstruction.

In some embodiments, SBR diagnostics 280 can receive samples from time-interleaved ADCs 144 operating using CLK 286 generated by PLL 252 that is controlled by clock recovery loop 260. SBR diagnostics 280 can reconstruct SBR based on the samples.

FIG. 3 illustrates clock recovery loop 260, according to some embodiments of the disclosure. Clock recovery loop 260 can include timing error detector (TED) 306, summing circuit 304, and PID 302. Clock recovery loop 260 is a feedback system. A stable operating point or equilibrium of the feedback loop action corresponds to a clock frequency that can minimize the timing error (e.g., timing error 320). The feedback loop action can drive the timing error to be zero or to be as small as possible at the stable operating point or equilibrium.

Equalizer 204 may reconstruct soft decisions 340 and output soft decisions 340 as outputs of equalizer 204. Slicer may output decisions 350, and output decisions 350 as outputs of slicer 206. The difference between soft decisions 340 and decisions 350 are referred to as errors 360.

TED 306 can receive outputs of slicer 206 (or decisions 350) and errors 360 for respective outputs of slicer 206. In some cases, TED 306 can receive outputs of slicer 206, outputs of equalizer 204. TED 306 can extract timing errors, utilizing techniques such as zero-forcing (ZF) TED, and Mueller-Muller TED. The techniques can rely on correlating receive (equalized) signals (e.g., outputs of equalizer 204) and the transmitted data sequence (e.g., outputs of slicer 206). For ZF TED, a timing error, de, can be calculated as follows:

$${φ}_{e} = e ( n ) \cdot [ d ( n + 1 ) - d ( n - 1 ) ] \qquad ( eq . 3 )$$

e(n) represents an error in errors 360. d(n) represents the received signal, such as outputs of slicer 206. d(n+1) and d(n−1) are consecutive transmitted data symbols. φₑ represents a timing error in parallel timing errors 330. TED 306 can calculate parallel timing errors 330 for respective time-interleaved ADCs 144, based on the respective outputs of parallel equalizers (shown collectively as equalizer 204) and the respective outputs of parallel slicers (shown collectively as slicer 206). TED 306 can calculate parallel timing errors 330 based on errors 360 and decisions 350, or based on soft decisions 340 and decisions 350. Each ADC in time-interleaved ADCs 144 produces a timing error in parallel timing errors 330.

Summing circuit 304 receives parallel timing errors 330 from TED 306. Summing circuit 304 aggregates parallel timing errors 330, through summing and/or averaging of the parallel timing errors 330, and outputs timing error 320. For example, summing circuit 304 can add parallel timing errors 330 and output timing error 320. Aggregating parallel timing errors 330 allows clock recovery loop 260 to cohesively reduce timing error 320 for all ADCs in time-interleaved ADCs 144.

PID 302 receives timing error 320 and outputs FCW 310 to control PLL 252. PID 302 determines FCW 310 based on or according to timing error 320. PID 302 carries out the feedback mechanism within clock recovery loop 260, processing the timing error 320 to control PLL 252. PID 302 minimizes timing error 320 by adjusting the clock frequency and phase through adjusting FCW 310 to cause clock recovery loop 260 to reach a stable operating point. In PID 302, the proportional component (P) can provide an immediate response proportional to the current timing error 320. The integral component (I) can accumulate past errors to compensate for long-term drifts. The derivative component (D) can predict future errors based on the rate of change. PID 302 maintains a stable clock signal under varying conditions, ensuring optimal sampling of the received signal by time-interleaved ADCs 144 at a stable operating point.

When parallel timing errors 330 are summed, a stable operating point of clock recovery loop 260 can be reached when φₑ(n)=0 ∀n. At the stable operating point, the frequency of CLK 286 is at the baud rate.

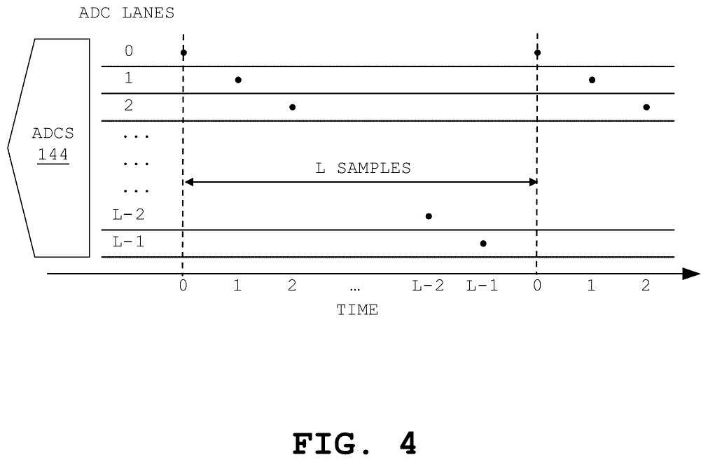

Referring briefly to FIG. 4, which shows that L individual time-interleaved ADCs (represented as ADC lanes l=0, 1, . . . . L−2, and L−1) sampling at different times, the stable operating point of clock recovery loop 260 can be reached when φₑ(l+Lj)=0 •l, j, where l represents the ADC lane number. ∀l means there are individual parallel timing errors for the L ADC lanes.

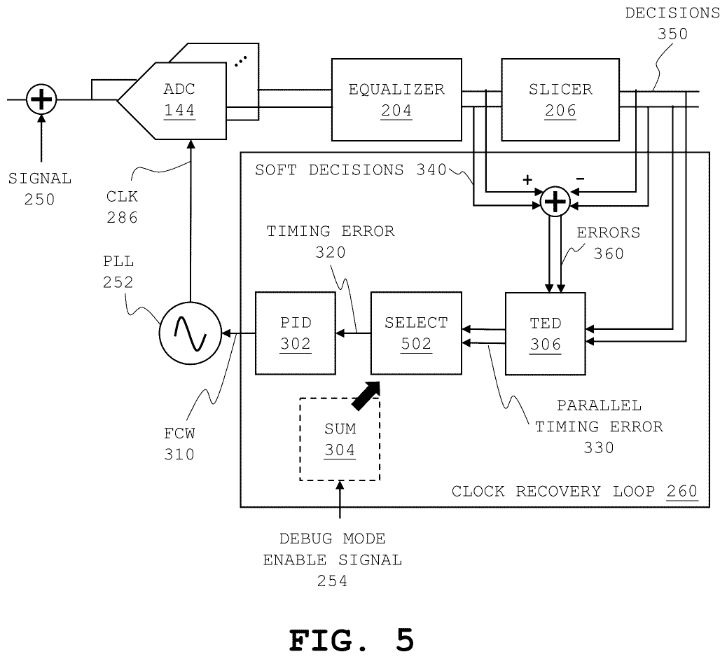

FIG. 5 illustrates a modified clock recovery loop 260 configured to achieve fractional lock, according to some embodiments of the disclosure. Instead of aggregating parallel timing errors 330, clock recovery loop 260 includes selection circuit 502 to select one of P parallel timing errors 330, or downsample parallel timing errors 330 at a rate of 1 out of P. Selection circuit 502 can output timing error 320 that is selected or downsampled from parallel timing errors 330.

Instead of adding parallel timing errors 330 as shown in FIG. 3, selection circuit 502 select one of P parallel timing errors 330 to output as timing error 320, thus implementing a subsampling or downsampling function at a rate of 1 out of P. Outputting timing error 320 by selection circuit 502 includes subsampling parallel timing errors 330. One timing error corresponding to one sample produced by one of the ADC lanes is used as feedback input to PID 302 in clock recovery loop 260. Several stable operating points of clock recovery loop 260, or several clock frequencies of CLK 286, can be reached when φₑ(Pj)=0. P represents the downsampling rate. Every P number of samples can correspond to an integer Q number of unit intervals (UIs). Suppose P=4 and Q=[1, 2, 3, 4, 5, . . . ], stable operating points at [¼*BR, ½*BR, ¾*BR, BR, 5/4BR, . . . ] can be reached by clock recovery loop 260. If P is large enough (e.g., 32, 64, or 128), it is possible to achieve stable operating points near BR, such that the clock frequency of CLK 286 is near BR, such as

$$\frac{P + 1}{P} * BR and \frac{P - 1}{P} * B R .$$

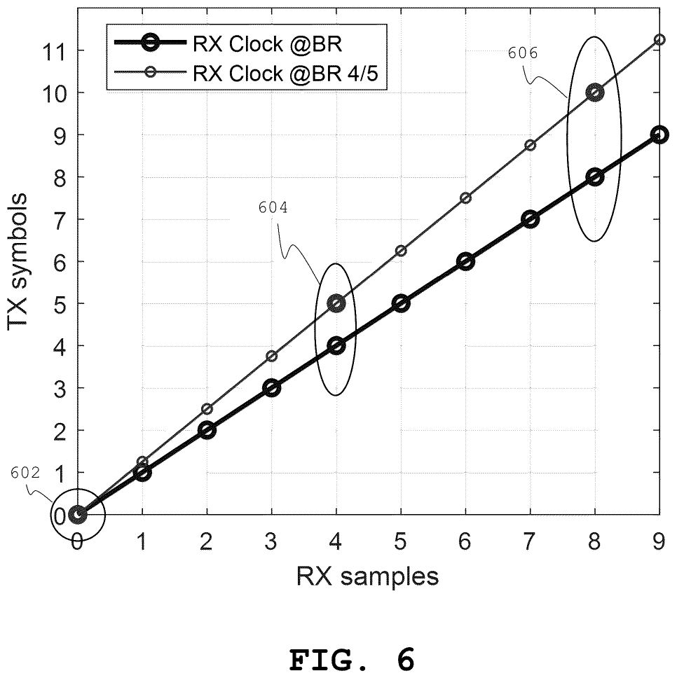

When one out of P of the parallel timing errors is used by the clock recovery loop as feedback (while other parallel timing errors are ignored or disregarded), the clock recovery loop would drive the selected timing error to 0 to reach a stable operating point. One of P parallel timing errors would cause the feedback action to speed up the clock or slow down the clock. The clock recovery loop can reach a stable operating point when both the RX sample and the TX sample are at an integer level, as seen at 602, 604, and 606 of FIG. 6 when P=5 and the clock frequency is fractionally locked at ⅘*BR (not at BR).

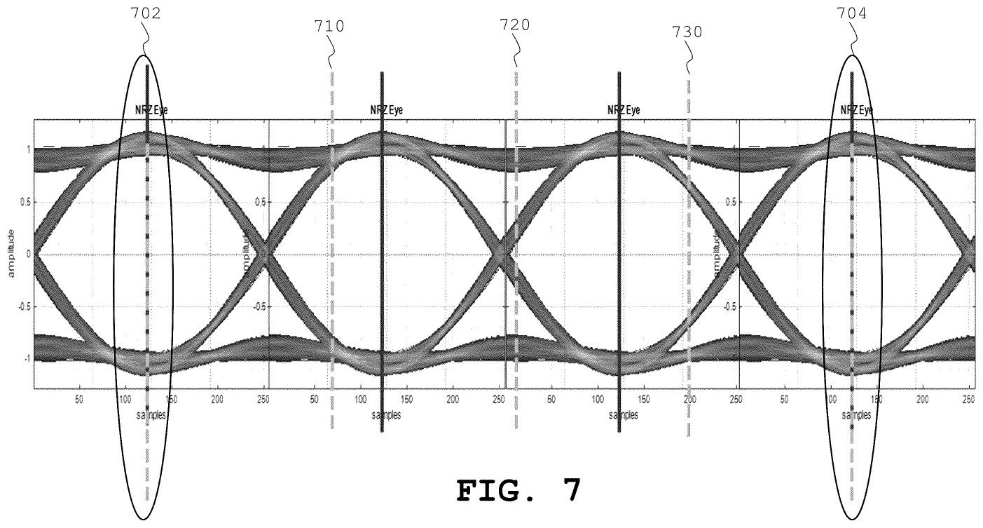

Similar behavior where sampling locks at the center of the eye even though the sampling frequency is not at BR can be seen at 702 and 704 of FIG. 7, when P=3 and the clock frequency is fractionally locked at ⅔*BR. The dashed lines represent sampling near BR, but not at BR. Some samples made at a frequency that is near BR may be out of phase, such as samples 710, 720, and 730, but these out of phase samples mean that samples at different phases can be obtained to reconstruct continuous time SBR. When the locked clock frequency is very close to BR, fine resolution samples at different phases can be made.

Referring back to FIG. 5, a circuit receiving parallel timing errors 330 can output timing error 320 in a manner according to debug mode enable signal 254 based on parallel timing errors 330. When debug mode enable signal 254 is inactive, the circuit may operate as summing circuit 304 of FIG. 3, such that clock recovery loop 260 is operating normally to reach a stable operating point where the frequency of CLK 286 is at BR.

When debug mode enable signal 254 is active, the circuit may operate as selection circuit 502, such that clock recovery loop 260 is operating in sampling scope mode to reach a stable operating point where the frequency of CLK 286 is near BR. Debug mode enable signal 254, e.g., when active, can configure the circuit to select one of parallel timing errors 330 and output the selected one of parallel timing errors 330 as timing error 320. In some embodiments, debug mode enable signal 254 can be applied to summing circuit 304 to configure summing circuit 304 into selection circuit 502. Applying debug mode enable signal 254 to clock recovery loop 260 can configure clock recovery loop 260 to subsample or downsample parallel timing errors 330.

Selection circuit 502 can output timing error 320 based on parallel timing errors 330 to drive PID 302. PID 302 may receive timing error 320 and output FCW 310. FCW is an input to PLL 252. When selection circuit 502 is downsampling parallel timing errors 330 and a selected timing error is used as timing error 320 to drive PID 302, PLL 252 outputs CLK 286 that has a frequency at a rational fraction of a baud rate (e.g., 64/65*BR, which has around 1% discrepancy relative to the ideal BR). Time-interleaved ADCs 144 are clocked CLK 286 to sample the received signal at the rational fraction of the BR.

When operating in the sampling scope mode, predetermined periodic signal 250 is applied at the input, and time-interleaved ADCs 144 samples the periodic input (e.g., predetermined periodic signal 250). In some embodiments, predetermined periodic signal 250 is a PRBS signal, such as a repeating pattern of a PRBS signal repeating over several periods.

Extracting SBR from ADC Samples Made at the Rational Fraction of the BR

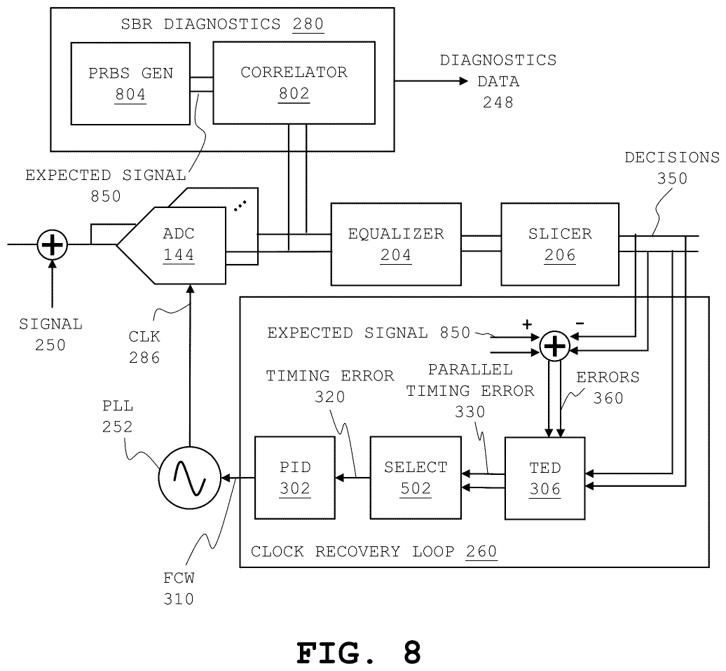

Besides configuring the clock recovery loop to operate in a sampling scope mode, a SBR diagnostics part can be added to the DSP to collect and optionally analyze the samples to produce diagnostics data. The SBR diagnostics part can extract diagnostics data corresponding to the SBR (e.g., reconstruct a continuous time SBR from the ADC samples) based on the outputs of the outputs of the time-interleaved ADCs sampling near the BR. Various implementations of the SBR diagnostics part are illustrated in FIGS. 8-10.

FIG. 8 illustrates determining SBR diagnostics data 248, according to some embodiments of the disclosure. SBR diagnostics 280 can include correlator 802. Correlator 802 can receive outputs of time-interleaved ADCs 144 and expected outputs of time-interleaved ADCs 144 (the expected outputs are shown collectively as expected signal 850). Correlator 802 can include hardware to estimate SBR in the DSP, by determining a cross-correlation between the outputs of time-interleaved ADCs 144 and expected outputs of time-interleaved ADCs 144. Correlator 802, when implemented in hardware, can be fast and efficient. Correlator 802 can calculate equation 2 to determine the cross-correlation of the outputs of time-interleaved ADCs 144 and expected outputs of time-interleaved ADCs 144. Correlator 802 can correlate the digital outputs of the time-interleaved ADCs 144 and expected outputs of the time-interleaved ADCs 144. Samples produced by time-interleaved ADCs 144 can be stored in a memory of correlator 802, such as a programmable FIFO memory. Expected outputs of time-interleaved ADCs 144, can be stored in a further memory of correlator 802, such as a programmable FIFO memory. Programmability of the memory and the further memory can change the timing alignment between the outputs of time-interleaved ADCs 144 and expected outputs of time-interleaved ADCs 144. The aligned data are multiplied together using a multiplier circuit to produce a product representing correlation values. The average of the products can be calculated by an averaging circuit to normalize the correlation values to produce the cross-correlation. Correlator 802 can operate on a subset or selection of outputs of time-interleaved ADCs 144.

In some embodiments, the expected outputs of time-interleaved ADCs 144, when sampling at a rational fraction of the BR, correspond to predetermined periodic signal 250 being sampled at the rational fraction of the BR. SBR diagnostics 280 can further include PRBS generator 804 to produce and output the expected outputs of time-interleaved ADCs 144. PRBS generator 804 can generate the expected outputs of time-interleaved ADCs 144 corresponding predetermined periodic signal 250 being sampled at the rational fraction of the BR.

In some embodiments, the expected signal 850 is used (in place of soft decisions produced by equalizer 204) to determine errors 360, which are used by TED 306 to determine parallel timing errors 330.

SBR diagnostics 280 may output diagnostics data 248 based on results of correlator 802.

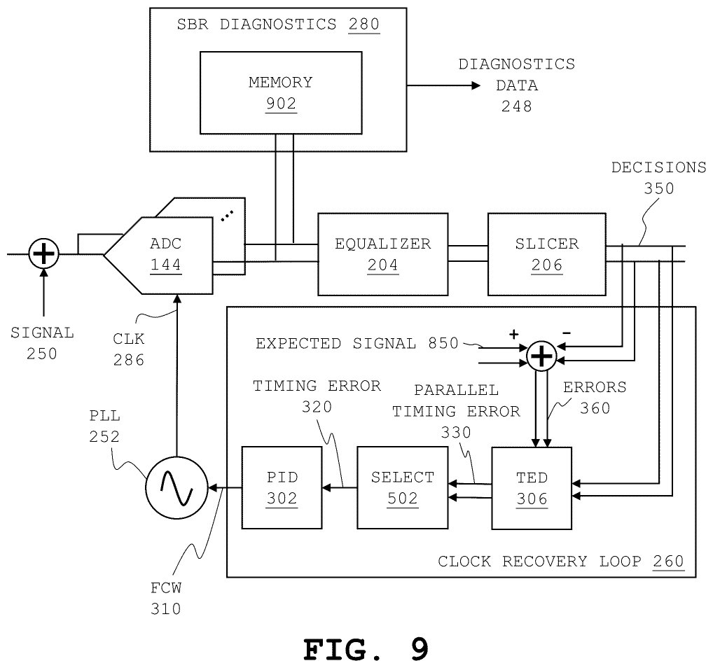

FIG. 9 illustrates determining SBR diagnostics data 248, according to some embodiments of the disclosure. SBR diagnostics 280 includes memory 902 to store outputs of the time-interleaved ADCs. Memory 902 can capture the digital outputs of time-interleaved ADCs 144. SBR diagnostics 280 can include a software correlator calculate equation 2. The software correlator can include an algorithm which can be executed on a processor (e.g., DSP) to calculate the cross-correlation between the digital outputs of time-interleaved ADCs 144 and the expected outputs of the digital outputs of time-interleaved ADCs 144.

Time-interleaved ADCs 144 when sampling near the BR (e.g., at

$$\frac{P - 1}{P} * B R )$$

and operating asynchronously with respect to the BR (the rate at which the symbols are transmitted on the RX channel), can produce P samples every P+1 transmitted symbols. Each ADC of time-interleaved ADCs 144 is sampling at a different phase. Stored samples in memory 902 can be used in post processing to extract SBR. Predetermined periodic signal 250 has a periodic pattern. If periodicity is co-prime with P+1 (e.g., periodicity for PRBS-N is 2^{N}−1), a full oversampled trace can be retrieved from a sufficiently large sized memory 902.

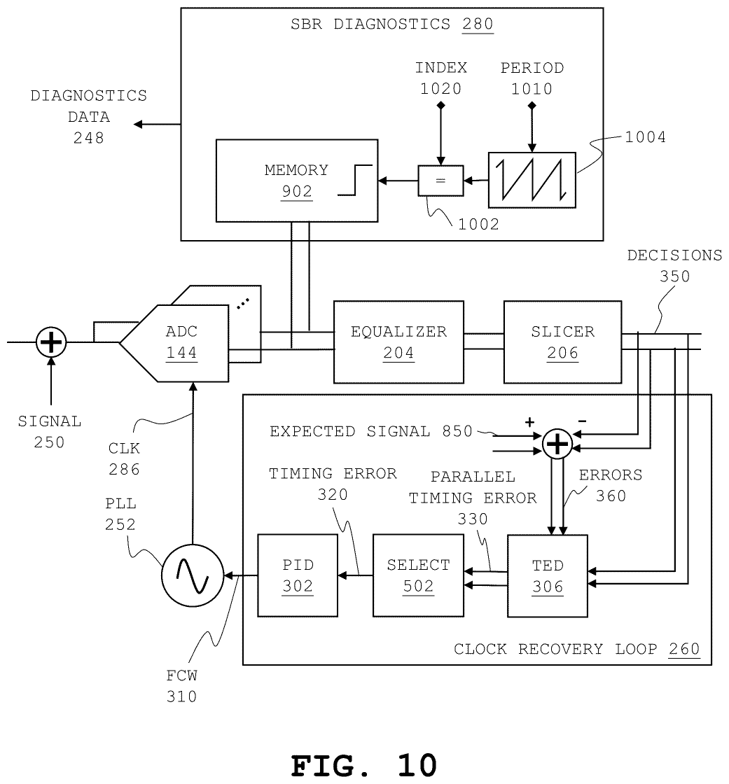

FIG. 10 illustrates determining SBR diagnostics data 248, according to some embodiments of the disclosure. A large memory that can store the full oversampled trace can be avoided by using a smaller memory with a trigger mechanism. Memory 902 can be triggered by the trigger mechanism to selectively capture the digital outputs of time-interleaved ADCs 144 that are going to be used to reconstruct the continuous time SBR while discarding other digital outputs which are not being used. The trigger mechanism can include counter 1004 having the same periodicity as predetermined periodic signal 250 to trigger memory dumps, e.g., to trigger a memory dump on a subset or a specific section of the outputs of time-interleaved ADCs 144. Counter 1004 can be a programmable counter and can perform counting according to period 1010 corresponding to the periodicity of predetermined periodic signal 250. Check 1002 can check if the counter value of counter 1004 is equal to index 1020. If the counter value of counter 1004 is the same as index 1020, then a memory dump for memory 902 is triggered. The size for memory 902 can be reduced.

### Exemplary Methods for Extracting an Oversampled SBR

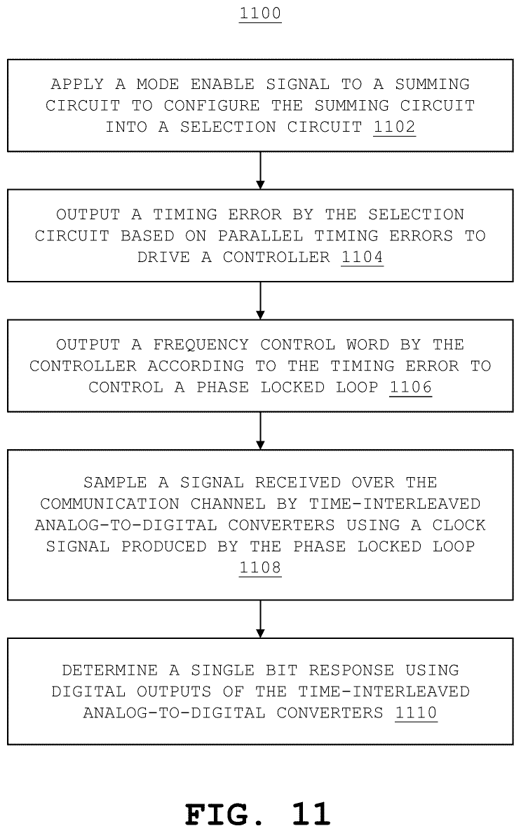

FIG. 11 depicts a flow chart illustrating a method to extract a single bit response using an augmented clock recovery loop achieving fractional lock, according to some embodiments of the disclosure. Method 1100 may be performed by components illustrated in FIGS. 5, and 8-10.

In 1102, a mode enable signal can be applied to a summing circuit to configure the summing circuit into a selection circuit. In some cases, the mode enable signal may activate an selection circuit to be used in place of the summing circuit.

In 1104, the selection circuit outputs a timing error based on parallel timing errors to drive a controller.

In 1106, the controller outputs a frequency control word according to the timing error to control a phase locked loop.

In 1108, time-interleaved ADCs samples a signal received over the communication channel using a clock signal produced by the phase locked loop.

In 1110, a single bit response can be determined using digital outputs of the time-interleaved ADCs.

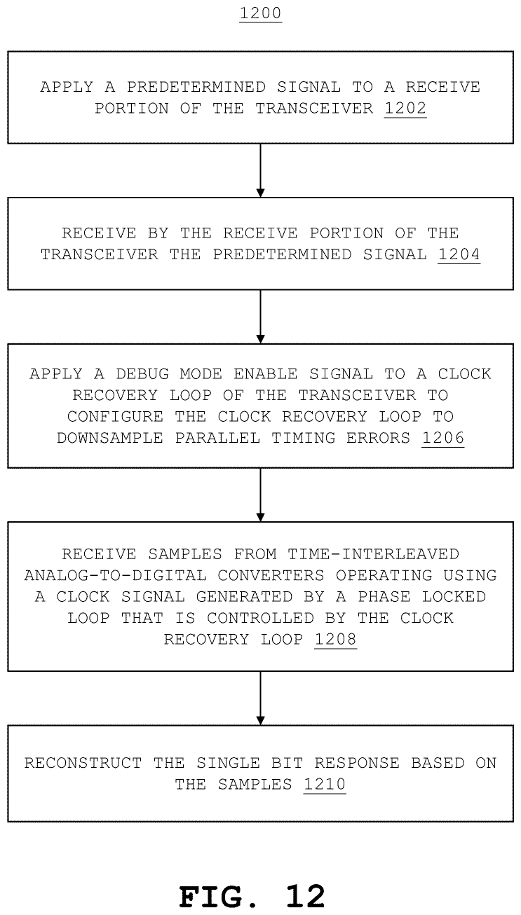

FIG. 12 depicts a flow chart illustrating a method to extract a single bit response using an augmented clock recovery loop achieving fractional lock, according to some embodiments of the disclosure. Method 1200 may be performed by components illustrated in FIGS. 5, and 8-10.

In 1202, a predetermined signal, e.g., a periodic predetermined signal sequence, can be applied to a receive portion of a transceiver (the SBR of the RX channel of the transceiver).

In 1204, the receive portion of the transceiver receives the predetermined signal.

In 1206, a debug mode enable signal can be applied to a clock recovery loop of the transceiver to configure the clock recovery loop to downsample parallel timing errors.

In 1208, samples can be received from time-interleaved ADCs operating using a clock signal generated by a phase lock loop that is controlled by the clock recovery loop.

In 1210, the single bit response can be reconstructed based on the samples.

### SELECT EXAMPLES

Example 1 provides a digital signal processor configured to extract a single bit response of a communication channel, the digital signal processor including equalizers coupled to respective outputs of time-interleaved analog-to-digital converters digitizing a predetermined signal; slicers coupled to respective outputs of the equalizers; and a clock recovery loop, including a timing error detector to receive outputs of the slicers and errors, and output parallel timing errors; a circuit to output a timing error according to a mode enable signal based on the parallel timing errors; and a controller to receive the timing error and output a frequency control word.
Example 2 provides the digital signal processor of example 1, where: the frequency control word is an input to a phase locked loop; the phase locked loop outputs a clock signal that has a frequency of a rational fraction of a baud rate; and the time-interleaved analog-to-digital converters are clocked by the clock signal.
Example 3 provides the digital signal processor of example 1 or 2, where the mode enable signal configures the circuit to select one of the parallel timing errors and output the selected one of the parallel timing errors as the timing error.
Example 4 provides the digital signal processor of any one of examples 1-3, further including a diagnostics part to extract diagnostics data corresponding to the single bit response based on outputs of the time-interleaved analog-to-digital converters.
Example 5 provides the digital signal processor of any one of examples 1-4, further including a correlator to receive the outputs of the time-interleaved analog-to-digital converters and expected outputs of the time-interleaved analog-to-digital converters.
Example 6 provides the digital signal processor of example 5, further including a pseudorandom binary sequence generator to output the expected outputs.
Example 7 provides the digital signal processor of example 5 or 6, where the expected outputs correspond to the predetermined signal being sampled at a rational fraction of a baud rate.
Example 8 provides the digital signal processor of any one of examples 1-7, further including a memory to store outputs of the time-interleaved analog-to-digital converters.
Example 9 provides the digital signal processor of example 8, further including a counter that has the same periodicity as the predetermined signal to trigger a memory dump on a subset of outputs of the time-interleaved analog-to-digital converters.
Example 10 provides a method for debugging a communication channel, the method including applying a mode enable signal to a summing circuit to configure the summing circuit into a selection circuit; outputting a timing error by the selection circuit based on parallel timing errors to drive a controller; outputting a frequency control word by the controller according to the timing error to control a phase locked loop; sampling a signal received over the communication channel by time-interleaved analog-to-digital converters using a clock signal produced by the phase locked loop; and determining a single bit response using digital outputs of the time-interleaved analog-to-digital converters.
Example 11 provides the method of example 10, where the clock signal produced by the phase locked loop has a frequency that is a rational fraction of a baud rate.
Example 12 provides the method of example 10 or 11, where the signal is a predetermined pseudorandom binary sequence signal.
Example 13 provides the method of any one of examples 10-12, where outputting the timing error by the selection circuit includes subsampling the parallel timing errors.
Example 14 provides the method of any one of examples 10-13, where determining the single bit response includes correlating the digital outputs of the time-interleaved analog-to-digital converters and expected outputs of the time-interleaved analog-to-digital converters.
Example 15 provides the method of example 14, where determining the single bit response includes generating the expected outputs corresponding to a predetermined signal being sampled at a rational fraction of a baud rate.
Example 16 provides the method of any one of examples 10-15, where determining the single bit response includes capturing the digital outputs of the time-interleaved analog-to-digital converters in a memory.
Example 17 provides the method of any one of examples 10-15, where determining the single bit response includes selectively capturing the digital outputs of the time-interleaved analog-to-digital converters in a memory.
Example 18 provides a method for extracting a single bit response for a transceiver, the method including applying a predetermined signal to a receive portion of the transceiver; receiving, by the receive portion of the transceiver, the predetermined signal; applying a debug mode enable signal to a clock recovery loop of the transceiver to configure the clock recovery loop to downsample parallel timing errors; receiving samples from time-interleaved analog-to-digital converters operating using a clock signal generated by a phase lock loop that is controlled by the clock recovery loop; and reconstructing the single bit response based on the samples.
Example 19 provides the method of example 18, where: the predetermined signal is applied using a transmit portion of the transceiver; and the predetermined signal is received via a loop back path from the transmit portion to the receive portion.
Example 20 provides the method of example 18 or 19, further including applying a debug mode start signal to the transceiver.
Example 21 provides an apparatus comprising means for performing any one of the method of examples 10-20.
Example 22 provides a transmitter having a transmit portion and a digital signal processor according to any one of examples 1-9.
Example 23 provides a receiver having a transmit portion and a digital signal processor according to any one of examples 1-9.
Example 24 provides a transceiver having a transmit portion, a receive portion, and a digital signal processor according to any one of examples 1-9.

### VARIATIONS AND OTHER NOTES

The detailed description, such as the “Select examples” section, provide various examples of the embodiments disclosed herein.

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A digital signal processor configured to extract a single bit response of a communication channel, the digital signal processor comprising:
equalizers coupled to respective outputs of time-interleaved analog-to-digital converters digitizing a predetermined signal;
slicers coupled to respective outputs of the equalizers; and
a clock recovery loop, comprising:
a timing error detector to receive outputs of the slicers and errors, and output parallel timing errors;
a circuit to output a timing error according to a mode enable signal based on the parallel timing errors; and
a controller to receive the timing error and output a frequency control word.

2. The digital signal processor of claim 1, wherein:
the frequency control word is an input to a phase locked loop;
the phase locked loop outputs a clock signal that has a frequency of a rational fraction of a baud rate; and
the time-interleaved analog-to-digital converters are clocked by the clock signal.

3. The digital signal processor of claim 1, wherein the mode enable signal configures the circuit to select one of the parallel timing errors and output the selected one of the parallel timing errors as the timing error.

4. The digital signal processor of claim 1, further comprising:
a diagnostics part to extract diagnostics data corresponding to the single bit response based on outputs of the time-interleaved analog-to-digital converters.

5. The digital signal processor of claim 1, further comprising:
a correlator to receive the outputs of the time-interleaved analog-to-digital converters and expected outputs of the time-interleaved analog-to-digital converters.

6. The digital signal processor of claim 5, further comprising:
a pseudorandom binary sequence generator to output the expected outputs.

7. The digital signal processor of claim 5, wherein the expected outputs correspond to the predetermined signal being sampled at a rational fraction of a baud rate.

8. The digital signal processor of claim 1, further comprising:
a memory to store outputs of the time-interleaved analog-to-digital converters.

9. The digital signal processor of claim 8, further comprising:
a counter that has the same periodicity as the predetermined signal to trigger a memory dump on a subset of outputs of the time-interleaved analog-to-digital converters.

10. A method for debugging a communication channel, the method comprising:
applying a mode enable signal to a summing circuit to configure the summing circuit into a selection circuit;
outputting a timing error by the selection circuit based on parallel timing errors to drive a controller;
outputting a frequency control word by the controller according to the timing error to control a phase locked loop;
sampling a signal received over the communication channel by time-interleaved analog-to-digital converters using a clock signal produced by the phase locked loop; and
determining a single bit response using digital outputs of the time-interleaved analog-to-digital converters.

11. The method of claim 10, wherein the clock signal produced by the phase locked loop has a frequency that is a rational fraction of a baud rate.

12. The method of claim 10, wherein the signal is a predetermined pseudorandom binary sequence signal.

13. The method of claim 10, wherein outputting the timing error by the selection circuit comprises subsampling the parallel timing errors.

14. The method of claim 10, wherein determining the single bit response comprises:
correlating the digital outputs of the time-interleaved analog-to-digital converters and expected outputs of the time-interleaved analog-to-digital converters.

15. The method of claim 14, wherein determining the single bit response comprises:
generating the expected outputs corresponding to a predetermined signal being sampled at a rational fraction of a baud rate.

16. The method of claim 10, wherein determining the single bit response comprises:
capturing the digital outputs of the time-interleaved analog-to-digital converters in a memory.

17. The method of claim 10, wherein determining the single bit response comprises:
selectively capturing the digital outputs of the time-interleaved analog-to-digital converters in a memory.

18. A method for extracting a single bit response for a transceiver, the method comprising:
applying a predetermined signal to a receive portion of the transceiver;
receiving, by the receive portion of the transceiver, the predetermined signal;
applying a debug mode enable signal to a clock recovery loop of the transceiver to configure the clock recovery loop to downsample parallel timing errors;
receiving samples from time-interleaved analog-to-digital converters operating using a clock signal generated by a phase lock loop that is controlled by the clock recovery loop; and
reconstructing the single bit response based on the samples.

19. The method of claim 18, wherein:
the predetermined signal is applied using a transmit portion of the transceiver; and
the predetermined signal is received via a loop back path from the transmit portion to the receive portion.

20. The method of claim 18, further comprising:
applying a debug mode start signal to the transceiver.
